(19) United States
(12) Patent Application Publication
(10) Pub. No.: US 2025/0228416 A1
(43) Pub. Date: Jul. 17, 2025

(54) WATERLESS TOILET SYSTEM

(71) Applicant: Royal Poo Company, LLC, East Norriton, PA (US)

(72) Inventor: Latasha Wharton, East Norriton, PA (US)

(21) Appl. No.: 18/413,873

(22) Filed: Jan. 16, 2024

(51) Int. Cl. A47K 11/02; A47K 11/12; C05F 3/06

(52) U.S. Cl. CPC A47K 11/02; A47K 11/12; C05F 3/06

(57) ABSTRACT

A waterless toilet system that includes a main body that includes a toilet bowl, a tank, a waste bin system, and a compost mixing wheel. The tank of the main body includes at least one internal compartment for storing and dispensing compost material into the waste bin system, and at least one compartment for storing hygienic products. The toilet bowl includes a movable toilet seat and toilet seat cover. Inside of the toilet bowl is a deployable urinal system that extends outwardly. The waste bin system in some exemplary embodiments includes a compost compartment and a separate urinal compartment. Inside of the compost compartment the waterless toilet system includes a mixing wheel in communication with an external pedal that is configured to cause rotational movement of the compost mixing wheel when depressed.

### FIELD OF THE INVENTION

The present invention relates generally to a toilet, and more particularly, to a waterless toilet system.

### BACKGROUND OF THE INVENTION

Composting toilets, which require little to no water, are a solution to sanitation and environmental problems in unsewered, rural, and suburban areas and in both the underdeveloped and developed countries. A composting toilet generally contains and processes excrement, carbon additive and sometimes, food waste. Unlike septic systems, a composting toilet relies on unsaturated conditions where aerobic bacteria break down waste.

Over the decades public health professionals have begun to recognize the need for environmentally sound human waste treatment and recycling methods. The composting toilet is a non-water system that is well suited for but not limited to remote areas where water is scarce, or areas with low percolation, high water tables, shallow soil, or rough terrain. Composting toilets eliminate the need for flush toilets, saving the usage of water for other necessities and allows for the recycling of valuable plant nutrients.

Although existing composting toilets provide a number of advantages, they also come with a number of disadvantages. For instance, maintenance of composting toilet systems requires more responsibility and commitment by the user and owners than conventional wastewater systems. Removal of the finished end-product is unpleasant if the compositing toilet is not properly installed or maintained. There is limited access and accessories that make the compost or waterless toilet more accessible and easier to maintain.

Accordingly, there is an established need for a waterless toilet that address any one of the aforementioned disadvantages that existing compost toilets do not address.

### SUMMARY OF THE INVENTION

The present invention is directed to a waterless toilet system. Introducing a first embodiment of the invention, the present invention consists of waterless toilet system comprising a main body that includes a toilet bowl, a tank, a lower compartment in fluid communicating with the toilet bowl, a urinal system, and a waste bin system having a compost mixing system. The toilet includes least one internal compartment configured to retain composting material and at least one compartment configured to store one or more hygienic products, and an external lever mechanically attached to a movable internal partition. The lower compartment of the toilet system is in fluid communication with the toilet bowl, and a toilet seat and a toilet seat cover are movably attached to the toilet bowl. Within the toilet bowl is the deployable urinal system. The waste bin system of the waterless toilet is removably disposed within the lower compartment of the main body and includes a compost compartment including a portion in fluid communication with the internal compartment of the tank and the toilet bowl, and a urine compartment including a portion in fluid communication with the deployable urinal system. In one exemplary embodiment, the compost mixing system includes at least one mixing wheel disposed within the compost compartment in communication with an external pedal that is configured to cause rotational movement of the compost mixing wheel when depressed.

In another aspect, the main body may include a toilet bowl cover movably attached between the toilet seat and the toilet seat cover. The toilet bowl cover is configured to cover a portion of the toilet bowl when in a closed configuration.

In another aspect, the deployable urinal system may comprise a urinal head connected to a telescoping conduit that is extendable and configured to extend the urinal head beyond the toilet bowl. The urinal system may further include a resilient lever that when engaged is configured to extend telescoping conduit or retract the telescoping conduit.

In another aspect, the main body of the waterless toilet system may include a lever mechanically connected to the deployable urinal system for securing the deployable urinal system in a fixed position.

In another aspect, the tank and or the lower compartment of the main body of the waterless toilet system may include a viewing window slit.

In another aspect, the waste bin system may include a bottom sliding door for removing material from the compost compartment.

In another aspect, the urine compartment can be detachable from the waste bin system.

In another aspect, the waterless toilet system may include disposed at each side of the main body a mounting member for securely receiving an accessory. The accessory in one exemplary embodiment comprises a collapsible stool.

In another aspect, the compost mixing system may comprise at least two mixing wheels disposed within the compost compartment in communication with an external pedal that is configured to cause rotational movement of each of the compost mixing wheels when continuously depressed.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a perspective view of a waterless toilet system in accordance with an embodiment of the instant invention;

FIG. 2 presents a left-side perspective view of the waterless toilet system exposing the internal compartment of the tank of the waterless toilet system and the urinal system inside of the toilet bowl;

FIG. 3 presents a right-side perspective view of the waterless toilet system showing the toilet bowl cover in between the toilet seat and the toilet seat cover of the waterless toilet system;

FIG. 4 presents a left-side perspective view of the waterless toilet system showing the urinal system and the waste bin system being deployed; and

FIGS. 5 and 6 present a perspective view of the waste bin system including a compost compartment and a urinal compartment;

FIG. 7 presents a perspective view of the waterless toilet system and a removably attachable accessory comprising a collapsible stool; and

FIG. 8 presents a cross-sectional view of the waterless toilet system taken from line 1-1 shown in FIG. 1.

Like reference numerals refer to like parts throughout the several views of the drawings.

### DETAILED DESCRIPTION

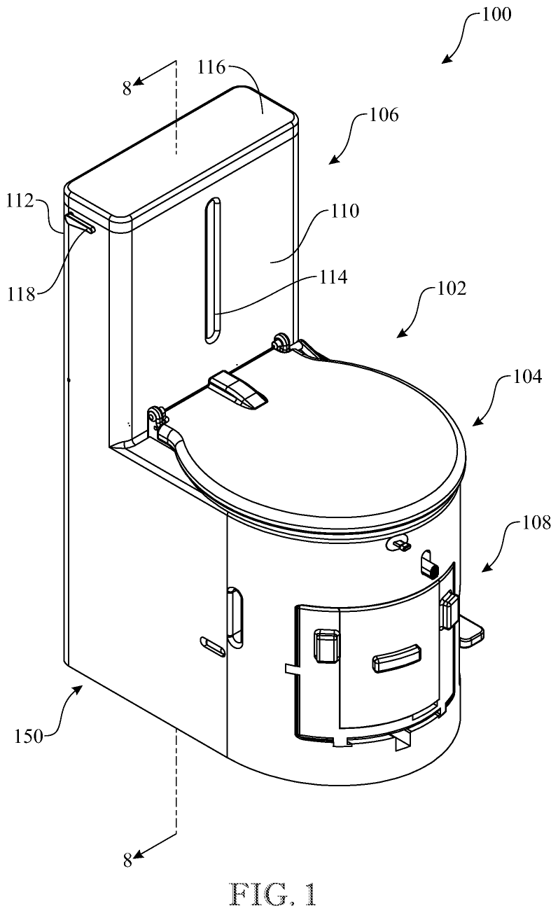

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

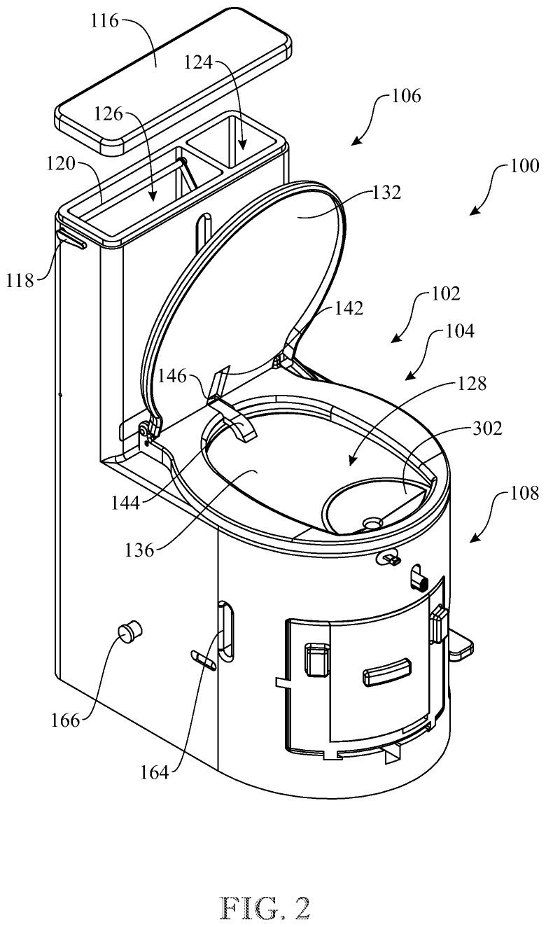

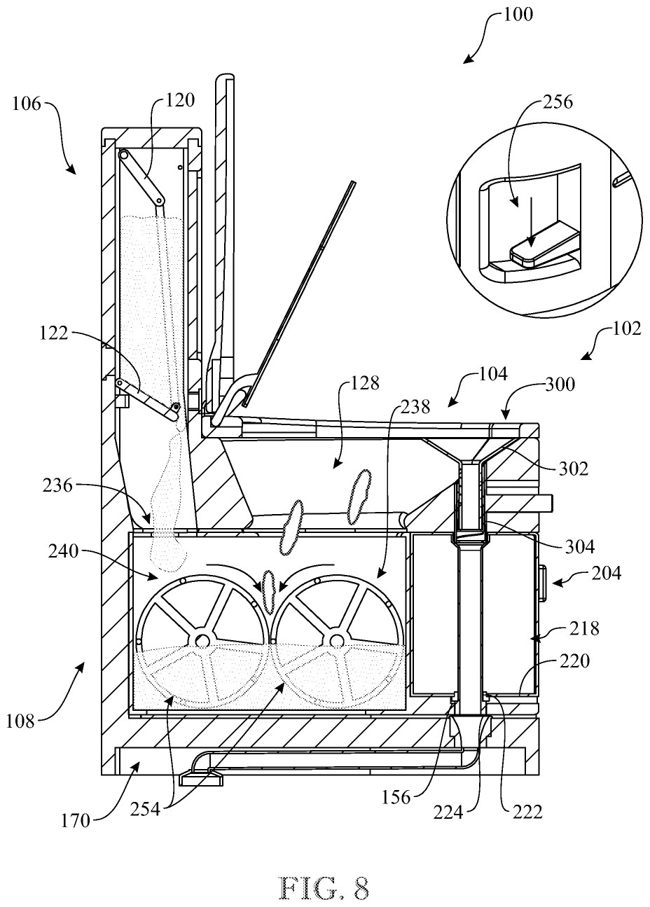

Referring initially to FIGS. 1 through 8, a waterless toilet system 100 is generally shown in accordance with an exemplary embodiment of the instant invention. The waterless toilet system 100 (hereinafter the “toilet”) generally comprises a main body 102 that includes a toilet bowl portion 104, a tank portion 106, a lower compartment portion 108, a waste bin system 200, and a urinal system 300. The tank portion 106 of the toilet 100 comprises a front end portion 110 and a flat surfaced rear end portion 112 delimiting a tank having an interior space that includes at least two compartments, a toiletry compartment 124 and a compost compartment 126, separated by an upstanding sidewall. The tank is covered by a tank cover 116, as shown in FIG. 2. Although the exemplary embodiment shown include at least two compartments, it should be readily understood that the tank portion 106 of the toilet 100 may comprise at least one compartment and not at least two without departing from the scope of the invention. Disposed on the outside of the tank portion 106 on a side surface of the toilet 100 is a discharge lever that is mechanically connected to a lever assembly 120 inside of the interior space of the tank. The lever assembly 120 is connected to a hinged partition member 122 (FIG. 8). Engagement of the lever 118 causes the partition member 122 disposed inside of the compost compartment 126 to pivot and allow material within the compost compartment 126 to flow downwardly. In one exemplary embodiment, the material retained within the compost compartment 126 is compost dirt commercially sold or organically harvested. At the front end 110 of the tank portion 106 of the toilet 100 is a viewing slit window 114 that grants viewable access to the internal content or material inside of the compost compartment 126 or toiletry compartment 124 or both. The toiletry compartment 124 is sized and otherwise configured to store and retain toiletry products such as toilet paper, biodegradable towelettes, or any other sanitary products.

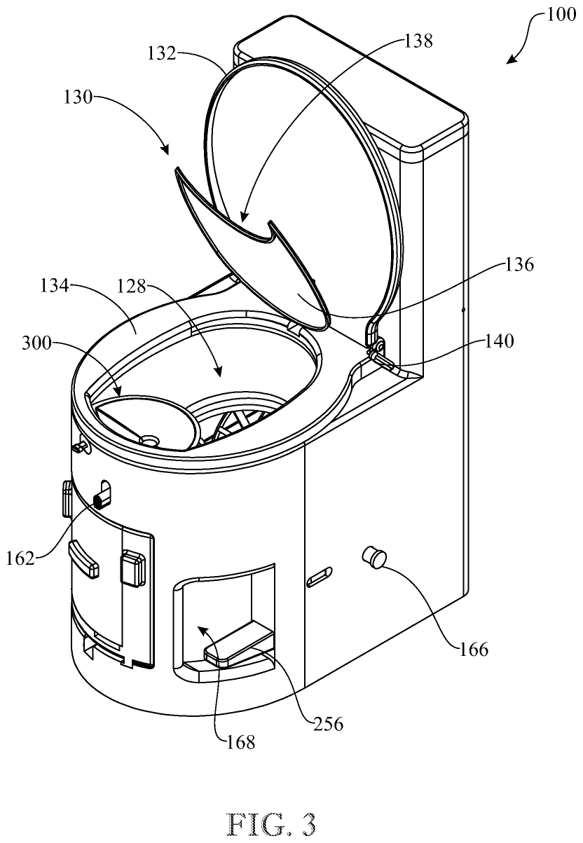

The toilet bowl portion 128 of the toilet 100 naturally extends from and continuous with the tank portion 106 of the toilet 100. The toilet bowl portion 128 includes an opening that communicates with the lower compartment 150 of the toilet 100. Removably attached to a top portion of the toilet bowl portion 128 of the toilet 100 is a toilet bowl cover assembly 130. The toilet bowl cover assembly in one exemplary embodiment comprises a toilet seat cover 132, a toilet seat 134, and a toilet bowl cover 136 disposed in between the toilet seat cover 132 and toilet seat 134, as illustrated in FIG. 3. The toilet bowl cover 136 includes a cut-out portion 138. The cut-out portion in one exemplary embodiment follows the same profile as a portion of the urinal head 302 of the urinal system 300 that is disposable within the toilet bowl portion 104 of the toilet 100. As exemplary shown, the cut-out may comprise a half-moon shaped cut-out; however, alternative cut-out shapes may be employed without departing from the scope of the invention.

As illustrated in FIG. 2, the toilet seat cover 132 includes a cut-out 142 about a distal end portion of the cover. The cut-out 142 is shaped and otherwise sized to allow an attachment arm 144 to pass there-through without being encumbered. The attachment arm 144 is attached at one end to the toilet bowl cover 136. Referring to FIG. 3, the toilet bowl cover assembly 130 is movably attached to a top end surface portion of the toilet bowl portion 104 of the toilet 100. The toilet bowl cover assembly 130, in one exemplary embodiment, includes a handle 140 that is mechanically attached to the attachment arm 144 attached to the toilet bowl cover 132. Manipulation of the handle 140 moves the toilet bowl cover 132 upwardly or downwardly about a pivot point 146 on a distal end of the attachment member 144 (FIG. 2). In one exemplary form, the toilet seat cover 132 and the toilet seat 134 are made out of any suitable plastic material, and the toilet bowl cover 136 is made out of a rubberized material that creates a seal between the edges of the opening of the toilet bowl and the edges of the urinal head 302, as seen in FIG. 2, to prevent odors from escaping the lower compartment, namely the waste bin system 200, of the toilet 100.

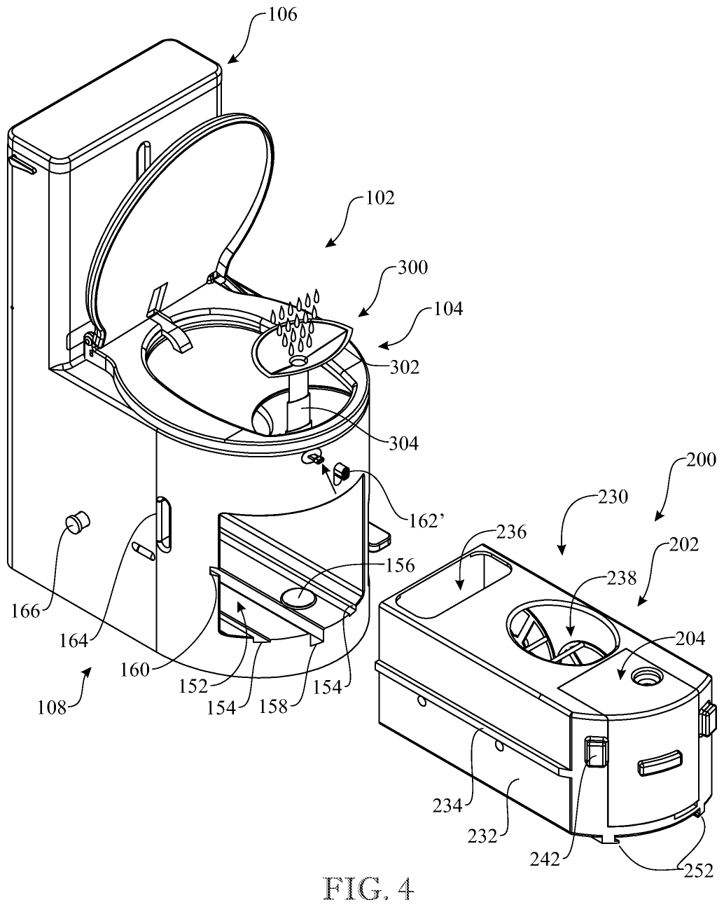

With reference to FIGS. 4 and 8, the toilet 100 includes a urinal system 300 that is disposable within the toilet bowl portion 128 of the main body 102 of the toilet 100. The urinal system 300 comprises a urinal head 302 attached to a conduit 304. In some exemplary embodiments, the conduit 304 attached to the urinal head is a telescoping conduit that is extendable and retractable, as seen in FIGS. 3 and 4. As best illustrated in FIG. 8, the urinal system 300 is entirely disposable within the toilet bowl portion 128 of the toilet. Meaning, the top end of the urinal head 304 sits flush with the top edge of the toilet bowl portion 128. The urinal system 300 is also covered by the toilet seat cover 132 when the toilet set cover is in a closed configuration, as shown in FIG. 1. The urinal system, however, is not covered by either the toilet seat 134 or the toilet bowl cover 138, as illustrated in FIG. 2. The urinal system 300 is mechanically connected to a release tab 306 that when engaged releases the urinal system, as seen in FIG. 4. In one exemplary embodiment, the release tab 306 is spring-loaded and when engaged deploys the telescoping conduit 304 of the urinal system upwardly.

Turning now to FIGS. 1, 4, and 8, the toilet 100 includes a lower compartment portion 150 that comprises a series of upstanding side walls delimiting an internal space 152 sized and otherwise configured to receive the waste bin system 200. At a bottom end surface of a wall surface delimiting the internal space, the lower compartment 150 includes a plurality of channels. In some embodiments, the lower compartment 150 includes one or more guide channels 154 that interact with guiding rails 252 on the waste bin system 200. The lower compartment also includes a channel for receiving a portion of the waste bin system 200. In some exemplary embodiments of the toilet 100, the lower compartment 150 may include an opening 156 with an attachable cap that communicates with the urinal compartment 204 of the waste bin system 200. As seen in FIG. 8, the opening 156 communicates with an optional bypass system that comprises a bypass conduit 224 disposed within a cavity 170 on the bottom end of the lower compartment 150. The bypass conduit 224 is connectable to a sewer line that is connected to a waste receiving system. To help guide and secure the waste bin system 200 into the lower compartment 150 of the toilet 100, the lower compartment includes side channels 160 provided about the side walls. On one or both sides of the lower compartment 150 of the toilet there is a viewing slit 164, and on one side, as seen in FIG. 3, the lower compartment includes a notch 168 on a side wall for a pedal 256. As seen on FIGS. 3 and 4, the toilet 100 includes a locking member 162 that protrudes outwardly from the front portion of the toilet 100. The locking member 162 includes internal components, as seen in FIG. 8, that lock the waste bin system 200 in place and the urinal system 300 in place. The locking member 162 can be toggled form a locked position (FIG. 3) to an unlocking position (FIG. 4). When in an unlocked position, the locking member 162′ disengages the urinal system 300 and the waste bin system 200. This allows the waste bin system 200 to be pulled out of the lower compartment 150 of the toilet 100, and the deployment of the urinal system 300 as described herein.

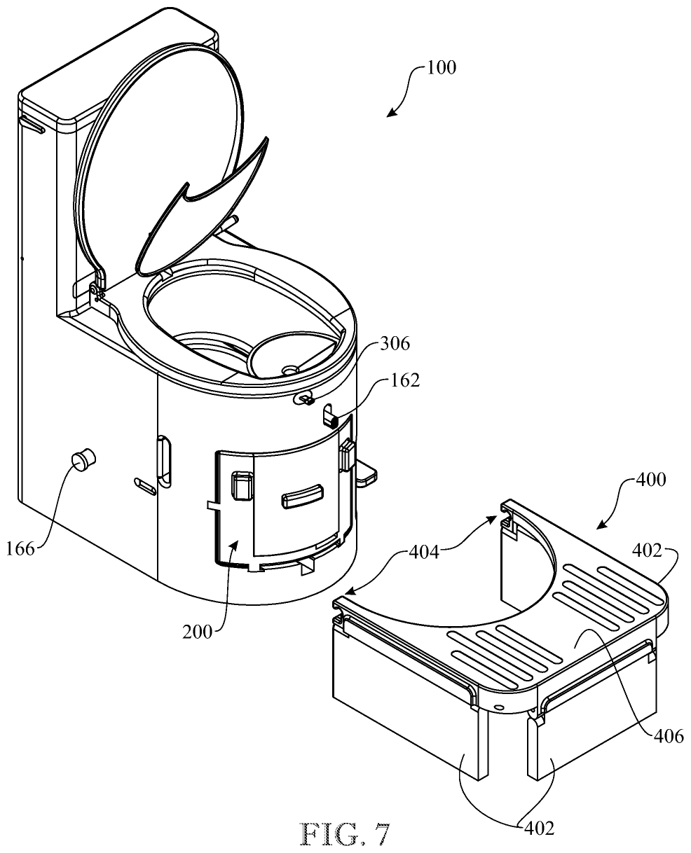

Referring to FIGS. 1 and 7, in some exemplary embodiments, the toilet 100 may include attachment tabs 166 that are designed and otherwise configured to engage an attachable accessory 400. The attachment tabs 166 may be removable or permanently attachable to the lower compartment 150 of the main body 102 of the toilet 100. The accessory 400, as seen in FIG. 7, may comprise a foot stool. In this exemplary embodiment, the foot stool accessory 400 comprises a plurality of collapsible supporting members 402 that are attached to a support platform 406. Disposed at a distal end of the accessory 400 are a pair of attachment heads 404 that engage the attachment tabs 166 on the lower compartment 150 of the toilet. The accessory stool 400 is removably attachable to the toilet 100.

Turning now to FIGS. 4, 6, and 8, the toilet 100 includes a waste bin system 200. The waste bin system 200 comprises a main body 202 including a urinal compartment body 204 and a compost compartment body 230. The urinal compartment body 204 comprises a plurality of sidewalls delimiting a receptacle space 218 for receiving fluid waste. At the top end 208 of the body 204, the urinal compartment includes an opening 206. The opening 206 aligns with the conduit 304 of the urinal system 300, as seen in FIG. 8. In some exemplary embodiments where the toilet includes a bypass conduit as discussed herein, the urinal compartment body 204 includes an evacuation member 214 that includes an opening 222 that projects downwardly from the bottom end 220 of the compartment. As seen in FIG. 8, the evacuation member 214 aligns with the bypass conduit 224. As shown in FIG. 6, the urinal compartment body 204 is detachable from the main body 202 of the waste bin system 200. The main body 202 may include a channel 212 for guiding the urinal compartment body 204 when mating the two together. Disposed about a front end of the urinal compartment 204 is one or more handles 216.

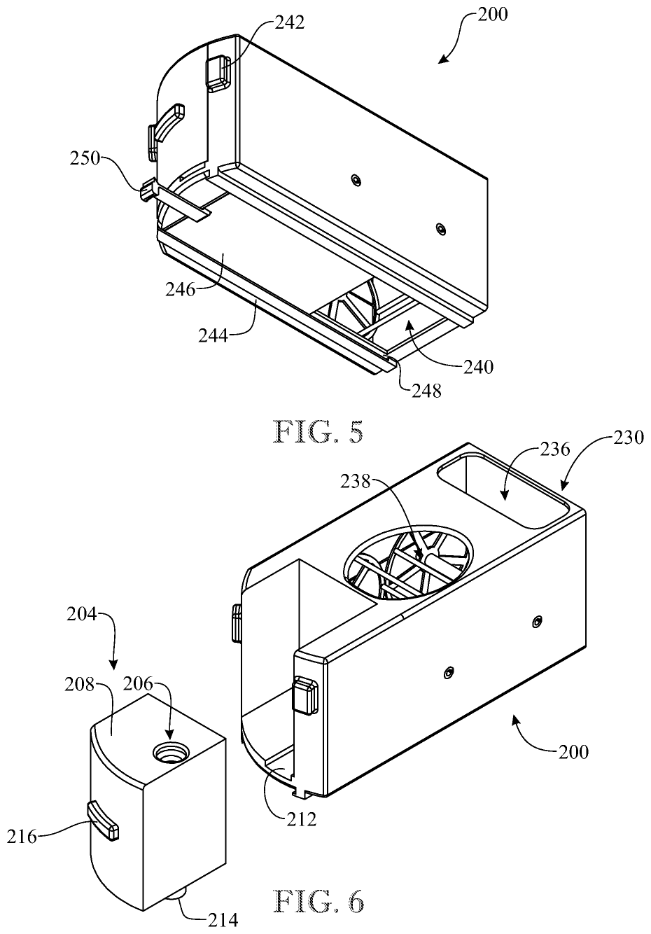

The waste bin system 200 of the toilet 100 also includes a compost compartment body 230 that comprises a plurality of sidewalls that delimit an internal receptacle space 240 configured to receive human waste and compost material from the tank 106 of the toilet 100. The side ends 232 of the main body 202 of the waste bin system 200 include side rails 234 that engage channels 160 on the lower compartment of the toilet 100. The compost compartment body 230 includes a first opening 236 and a second opening 238 in a first exemplary embodiment. A singular opening, however, is employable without departing from the scope of the invention. At the bottom of the main body 202 of the waste bin system 200, the compost compartment body 230 includes a removable or slidable bottom end 244. As exemplary shown in FIG. 5, the bottom end may comprise a slidable door 246 that slides about opposing channels 248 on the main body 202. The sliding door 246 includes a pull handle 250 for removing or securing the door from the main body 202. When the door 246 is removed from the main body 202, as shown in FIG. 5, the material inside of the receptacle space 240 of the compost compartment body 230 is removable.

With particular reference to FIG. 8, the first opening 236 of the compost compartment 230 of the waste bin system 200 aligns with the internal space of the tank 106, so that material from the tank can flow into the receptacle space 240 of the compost compartment 230. The second opening 238 of the compost compartment 230 aligns with the opening of the toilet bowl 128, so to allow waste material to flow into the receptacle space 240. Disposed within the receptacle space 240 of the compost compartment of the waste bin system is one or more mixing wheels 254. The mixing wheels are connected to a worm gear that connects to a drive gear that in cam action connects to the pedal 256 of the toilet 100. Engagement of the pedal 256 activates rotational movement of the mixing wheels 254, with each wheel configured to rotate in opposing direction from the other. For example, if one wheel turns clock-wise, the opposing wheel turns counter-clockwise. It should be readily understood, however, that at least one mixing wheel may be used with the toilet 100 without departing from the scope of the invention. The mixing wheels are designed and otherwise configured to mix waste material with compost material, as seen in FIG. 8.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A waterless toilet system, comprising:
a main body including,
a toilet bowl;
a tank having at least one internal compartment configured to retain composting material, an external lever mechanically attached to a movable internal partition,
a lower compartment in fluid communication with the toilet bowl,
a toilet seat and a toilet seat cover movably attached to the toilet bowl, and
a deployable urinal system disposed within the toilet bowl;
a waste bin system removably disposed within the lower compartment of the main body, the waste bin including a compost compartment including a portion in fluid communication with the internal compartment of the tank and the toilet bowl, and a urine compartment including a portion in fluid communication with the deployable urinal system; and
a compost mixing system comprising at least one mixing wheel disposed within the compost compartment in communication with an external pedal that is configured to cause rotational movement of the compost mixing wheel when depressed.

2. The waterless toilet system of claim 1, wherein the main body includes a toilet bowl cover movably attached between the toilet seat and the toilet seat cover, the toilet bowl cover configured to cover a portion of the toilet bowl when in a closed configuration.

3. The waterless toilet system of claim 1, wherein the deployable urinal system comprises a urinal head connected to a telescoping conduit that is extendable and configured to extend the urinal head beyond the toilet bowl.

4. The waterless toilet system of claim 3, wherein a resilient lever is connected to the deployable urinal system and when engaged is configured to deploy the extendable telescoping conduit or retract the telescoping conduit.

5. The waterless toilet system of claim 1, wherein the main body includes a lever mechanically connected to the deployable urinal system for securing the deployable urinal system in a fixed position.

6. The waterless toilet system of claim 1, wherein the tank includes a compost material level viewing window slit.

7. The waterless toilet system of claim 1, wherein the lower compartment includes a compost material and waste level viewing window slit.

8. The waterless toilet system of claim 1, wherein the waste bin system includes a bottom sliding door for removing material from the compost compartment.

9. The waterless toilet system of claim 1, wherein the urine compartment is detachable from the waste bin system.

10. The waterless toilet system of claim 1, wherein disposed at each side of the main body is a mounting member for securely receiving an accessory.

11. The waterless toilet system of claim 10, wherein the accessory comprises a collapsible stool.

12. The waterless toilet system of claim 11, wherein the main body includes an interior compartment sufficiently sized for storing the collapsible stool.

13. The waterless toilet system of claim 1, wherein the urine compartment comprises a main receptacle body including a top end opening for receiving a portion of the deployable urinal system.

14. The waterless toilet system of claim 13, wherein the main receptacle body includes a bottom end evacuation opening for selectively receiving a sealing cap or a bypass conduit.

15. The waterless toilet system of claim 1, wherein the main body includes a substantially flat rear end surface.

16. A waterless toilet system, comprising:
a main body including,
a toilet bowl;
a tank having at least one internal compartment configured to retain composting material and at least one compartment configured to store one or more hygienic products, an external lever mechanically attached to a movable internal partition,
a lower compartment in fluid communication with the toilet bowl, a toilet seat, a toilet bowl cover, and a toilet seat cover movably attached to the toilet bowl, and
a deployable urinal system disposed within the toilet bowl;
a waste bin system removably disposed within the lower compartment of the main body, the waste bin including a compost compartment including a portion in fluid communication with the internal compartment of the tank and the toilet bowl, and a urine compartment including a portion in fluid communication with the deployable urinal system; and
a compost mixing system comprising at least two mixing wheels disposed within the compost compartment in communication with an external pedal that is configured to cause rotational movement of each of the compost mixing wheels when continuously depressed.

17. The waterless toilet system of claim 16, wherein disposed at each side of the main body is a mounting member for securely receiving an accessory.

18. The waterless toilet system of claim 17, wherein the accessory comprises a collapsible stool.

19. A waterless toilet system, comprising:
a main body including,
a toilet bowl;
a tank having at least one internal compartment configured to retain composting material and at least one compartment configured to store one or more hygienic products, an external lever mechanically attached to a movable internal partition,
a lower compartment in fluid communication with the toilet bowl,
a toilet seat, a toilet bowl cover, and a toilet seat cover movably attached to the toilet bowl, and
a deployable urinal system disposed within the toilet bowl, the deployable urinal system including a urinal head connected to a telescoping conduit that is extendable;
a waste bin system removably disposed within the lower compartment of the main body, the waste bin including a compost compartment including a portion in fluid communication with the internal compartment of the tank and the toilet bowl, and a urine compartment including a portion in fluid communication with the telescoping conduit of the deployable urinal system; and
a compost mixing system comprising at least two mixing wheels disposed within the compost compartment in communication with an external pedal that is configured to cause rotational movement of each of the compost mixing wheels when continuously depressed.

20. The waterless toilet system of claim 19, wherein the tank includes a compost material level viewing window slit, and the lower compartment includes a compost material and waste level viewing window slit.
